(19) United States
(12) Patent Application Publication
(10) Pub. No.: US 2006/0266379 A1
(43) Pub. Date: Nov. 30, 2006

(54) Hair weave tract extraction device

(76) Inventor: Michelle Shelton, Detroit, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/395,015

(22) Filed: Mar. 31, 2006

Related U.S. Application Data
(60) Provisional application No. 60/684,675, filed on May 26, 2005.

(51) Int. Cl. B26B 11/00; A45D 44/00

(52) U.S. Cl. 132/333; 30/123

(57) ABSTRACT

A hair weave thread extraction device having a first elongated support and a second pivotally attached and elongated support. Opposing surfaces of the first and second supports define at least a blade and an anvil support. The first elongated support exhibits an inwardly facing blade, whereas the second elongated support is a recessed surface coacting with the blade. An actuating lever pivots the first and second elongated supports together in coacting fashion. The pivot point further includes a collar-shaped fulcrum, the first and second supports overlapping in substantially parallel fashion and terminating in substantially pointed ends.

### CROSS REFERENCE TO RELATED APPLICATIONS

The present application claims the priority of U.S. Provisional Patent Application Ser. No. 60/684,675, filed May 26, 2005, for “Hair Weave Tract Extraction Device”.

### BACKGROUND OF THE INVENTION

1. Field of the Invention

The present invention is a tract extraction device for safely removing hair weave tracts associated with given hair styling. The present invention is an improvement over prior art tract removal devices, such as conventional scissors, in that it provides a comfortable hand grip design for ease of use, accuracy and safety in sectioning and cutting hair extender threads and separating the hair.

2. Description of the Prior Art

The prior art is well documented with examples of hair weave creation and attachment devices. The objective in each instance is ability to create an attractive hair weave pattern, by which a selected segment of the user's hair is refashioned in a desired manner.

U.S. Patent Application Publication No. 2003/0075196 to Fair discloses a hair weave attachment device having a plurality of pin-like protrusions extending from a flexible band. A plurality of pin-like protrusions provide a method for attaching the hair weave attachment device, having the hair weave attached thereto, to a wearer.

Japanese Patent Abstract No. 09105093 teaches a permanent hair wave forming implement including a sheet of a water-absorbent and non-woven fabric (mesh like) material, to which is attached a winding rod having a hollow cylindrical body with a rubber band extending from one end. Upon the sheet being wound about the rod, to which in turn is held a segment of a user's hair, the rubber band is stretched to engage an opposite end of the rod in affixed fashion.

### SUMMARY OF THE INVENTION

The present invention discloses a hair thread extraction device having a first elongated support and a second pivotally attached and elongated support. Opposing surfaces of the first and second supports define at least a blade and an anvil support. The first elongated support exhibits an inwardly facing blade, whereas the second elongated support is a recessed surface coacting with the blade.

An actuating lever pivots the first and second elongated supports together in coacting fashion. The pivot point further includes a collar-shaped fulcrum, the first and second supports overlapping in substantially parallel fashion and terminating in substantially pointed ends.

A further variant discloses a hairpin shaped and outwardly biasing component disposed between the blade and anvil supports and supported about the collar-shaped fulcrum. The use of the hairpin component substitutes for the pre-stressing of the blade and anvil components in an outward/opposite biasing fashion.

Additional features include a plurality of comb teeth extending in spaced apart and parallel fashion from an end of the device opposite said blade and anvil support. A plasticized handle fixedly supports the first elongated support, the handle further exhibiting an ergonomic configuration.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an underside perspective view of a hair weave tract extraction device according to a preferred embodiment of the present invention;

FIG. 2 is a bottom view of the device illustrated in FIG. 1;

FIG. 3 is an end view of the device of FIG. 1;

FIG. 4 is a top view of the device of FIG. 1;

FIG. 5 is a front view of the device of FIG. 1;

FIG. 6 is a rear view of the device of FIG. 1;

FIG. 7 is an enlarged partial illustration of the opposing surfaces of the blade and an anvil support;

FIG. 8 is an illustration similar to that shown in FIG. 3 and in which the lever of the device of FIG. 1 is configured in a stored position;

FIG. 9 is a perspective illustration of a one-piece hair weave tract extraction device according to a further preferred embodiment of the present invention;

FIG. 10 is a plan view of a tract extraction device according to a further preferred embodiment of the present invention and exhibiting an ergonomically configured handle;

FIG. 11 is a plan view of a tract extraction device according to a yet further preferred embodiment and including a smoothed handle;

FIG. 12 is a plan view of a still further tract extraction device and illustrating an arcuately configured handle;

FIG. 13 is an underside perspective view of a hair weave tract extraction device according to a yet further preferred embodiment of the present invention and illustrating the provision of a hairpin shaped and outwardly biasing component disposed between the blade and anvil supports and supported about the collar-shaped fulcrum;

FIG. 14 is a plan view of the hair weave tract extraction device according to FIG. 13;

FIG. 15 is an enlarged partial view of the blade and anvil supports and hairpin shaped component illustrated in FIG. 13 from a first perspective; and

FIG. 16 is a further rotated and partial view perspective of FIG. 14.

### DETAILED DESCRIPTION OF THE PREFERRED EMBODIMENTS

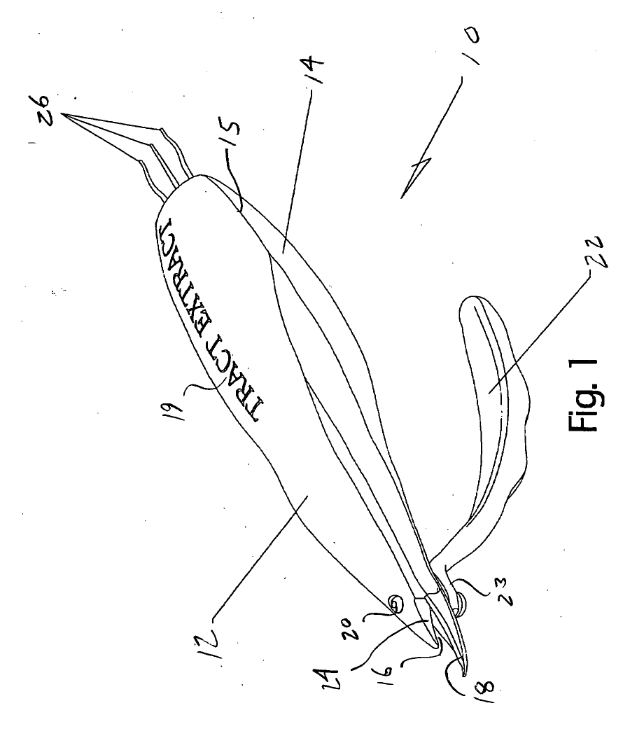

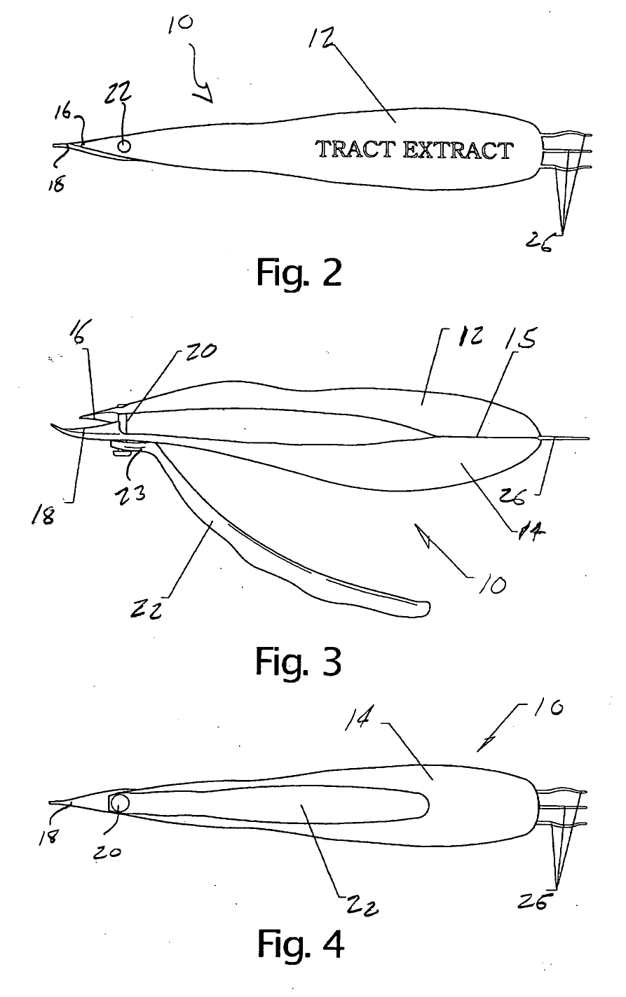

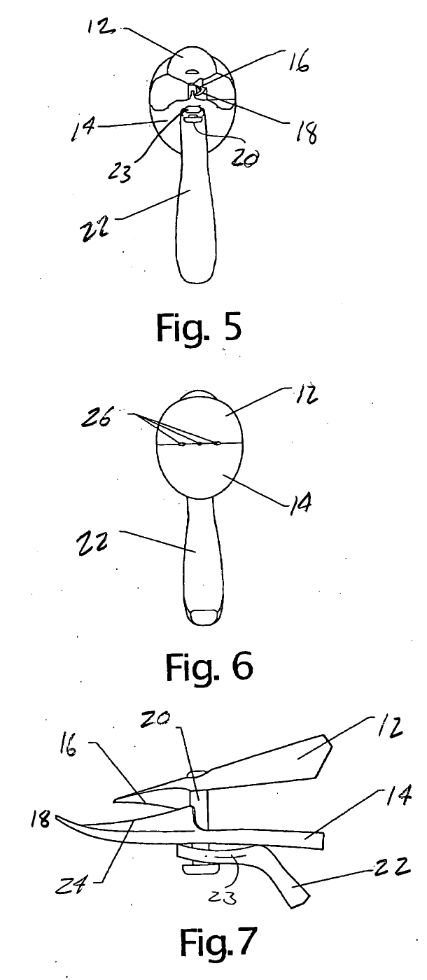

Referring to FIGS. 1-4, a series of perspective and plan views are illustrated at 10 of a hair weave tract extraction device according to a first preferred embodiment of the present invention. As described previously, the purpose of the hair weave extraction device 10 is to operate to safely remove hair weave tracts, such as threads, which are utilized in the creation of hair weave extenders.

The tract extraction device 10 is similar in respects to a conventional nail-clipper device and includes a pair of elongated supports, these termed blades 12 and 14, the blade 12 exhibiting a first arcuately extending point 16 and the second blade 14 exhibiting a further arcuately extending point 18.

The blades further typically interconnect, at 15, in a unitary body portion. A written indicia 19 (see again FIG. 1) can be imprinted upon the body and such as identifying a commercial name associated with the device 10.

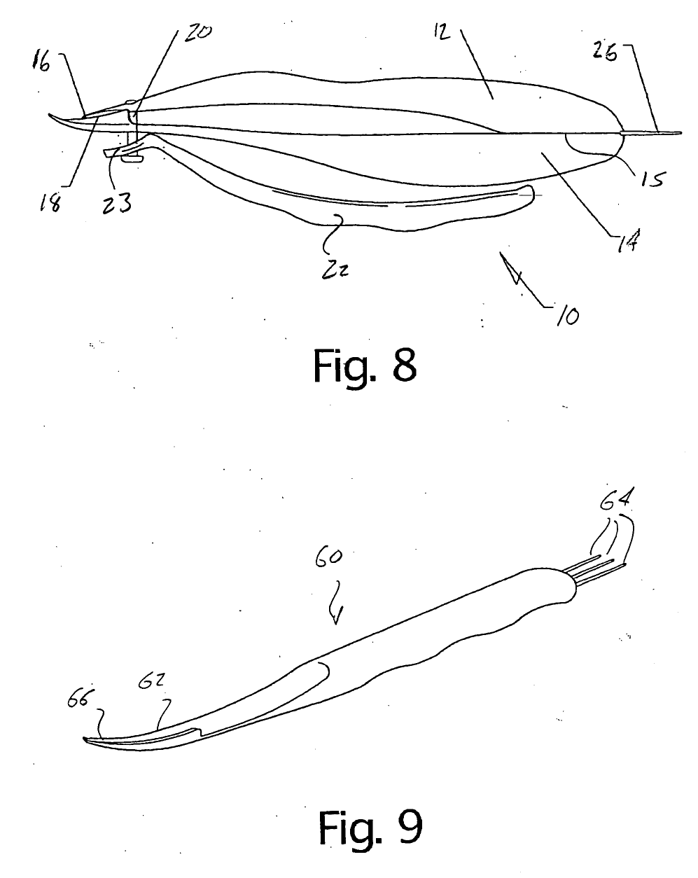

At a generally opposite end, a fulcrum 20 is provided, typically in the form of a collar, and extends between intermediate locations of the blades 12 and 14 such that, upon the pivoting actuation of a lever 22, the fulcrum 20 causes the blades, which are arrayed in substantially parallel and planar fashion, to displace together in guiding and controlled fashion. The lever 22 further includes an angled end portion 23 which interconnects an exterior location of the fulcrum 20, i.e., on an exterior face of the blade 14. This causes the blades 12 and 14 to displace inwardly together at the location of the fulcrum when positioned in the engaging configuration of FIG. 3 and to convert to a storage/non-displacing condition according to the configuration of FIG. 8.

The blade 12 further includes a cutting zone 24 (see in particular FIG. 1) located in extending fashion proximate its arcuately extending point 16. The cutting zone 24 engages the extending location 18 of the blade 14, this operating as a recessed or seating anvil.

Upon displacing the blades together, to the point in which the extending tip 16 of blade 12 contacts an opposing surface of blade 14, a hair weave tract (again not shown but understood to consist of a rubber band, clip or other suitable article known in the prior art for holding a segment of hair together in a desired fashion) extending therebetween is entrapped and caused to be sectioned. Extending from an opposite end of the device 10 is a plurality of elongated comb portions 26 and which provide for routine hair maintenance following sectioning and during removal of the extender threads and subsequent hair grooming.

Referring now to FIG. 10, a plan view is illustrated at 28 of a tract extraction device according to a further preferred embodiment of the present invention. The device 28 exhibits an overall length of several inches, give or take, in a preferred embodiment and includes a plasticized and ergonomically configured handle 30. Extending along one surface of the handle 30 are a plurality of recesses 32 and projections 34 and which in combination define an ergonomically configured gripping surface for the device 28. The grip 30 is further typically 3½″ inches in length, approximately ½″ in diameter, and includes a plurality of three or four hardened plastic comb teeth, see at 35, these operating substantially as previously described.

A sectioning component of the device 28 includes a first fixed scissor component 36 secured inside a center of the handle 30 and extending substantially linearly from an end of the handle 30, terminating in an elongated support 38 with a rounded edge 39. A secondary scissor (lever) component 40 is pivotally secured, via pin 42, to the first fixed component 36.

The lever 40 includes an extending support end 44, terminating in a rounded edge 45, and from which inwardly projects a smooth rounded blade 46. An opposing inner surface 48 of the support 38 functions as an anvil surface upon the blade 46 being pivoted into abutting engagement and causes sectioning of the hair thread positioned therebetween.

An opposite projecting end 50 of the pivoting lever 40 provides an actuating surface located in proximity to the handle 30 and which may be actuated by the user in pivoting the cutting surfaces towards and away from each other. It is also envisioned that any suitable type of spring biasing component can be incorporated into the design and in order to cause the lever 40 to be deflected into a normally opened position, thus enhancing its ease of operation.

In a preferred variant, the metal lever is approximately 1″ long and ¼″ wide and controls the motion of the blade, as well as providing stability to ensure an accurate cut. The opposing blade surfaces are further approximately ¾″ in length from the point of their pivotal connection 42 to their end extending and rounded edges 39 and 45.

In operation, the point of the bottom blade is thin, rounded and smooth to prevent premature cutting. The blade is inserted between the hair and the hair thread lifted up and cut (this in order to prevent the hair from being cut instead).

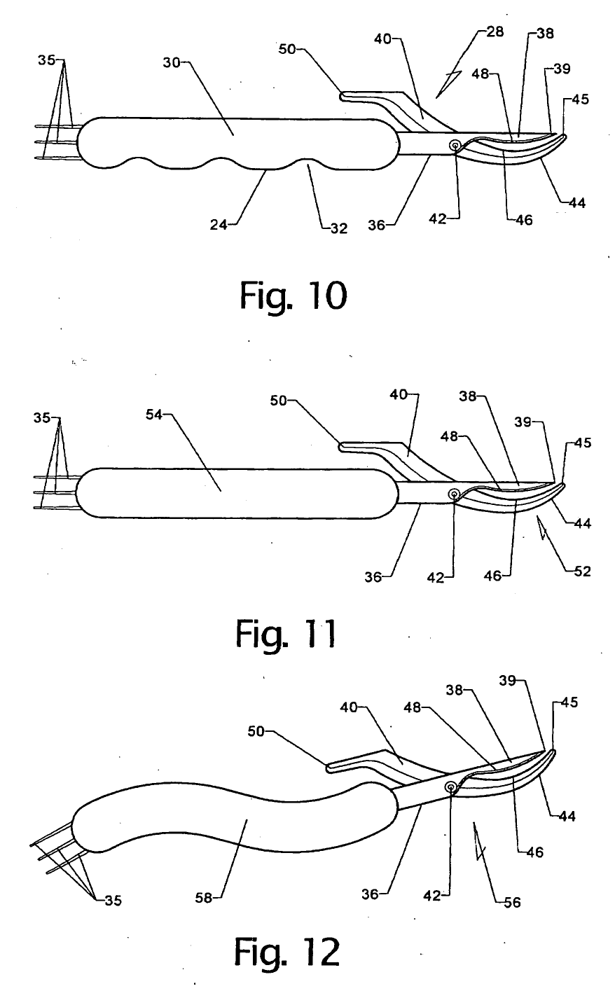

Referring now to FIG. 11, a plan view is shown at 52 of a tract extraction device according to a yet further preferred embodiment. The device 52 is functionally identical to that described in detail with reference to FIG. 4; accordingly a repeat description of common components will not be made. The device 52 does however include a smoothed handle 54, as opposed to the ergonomically configured handle 30.

Referring further to FIG. 12, a plan view 56 is shown of a still further tract extraction device and illustrating an arcuately configured handle 58. In each instance, the plastic handle may be produced in a variety of different shapes or colorings as desired.

As is further shown in FIG. 9, a single piece tract extraction device is shown at 60 according to a yet further preferred embodiment. The device 60 includes an elongated, arcuately configured and typically plastic body exhibiting a single configured blade edge 62 terminating at a first arcuate and pointed end, and combined with comb portions 64 extending from the second end. In use, the arcuate tip, see at 66, is engaged with a selected hair weave tract and such that, upon pivoting the blade edge outward, the selected hair weave tract is severed.

Referring now to FIG. 13, an underside perspective view is shown at 68 of a hair weave tract extraction device according to a yet further preferred embodiment of the present invention. Many of the features illustrated in preceding embodiments are repeated in the embodiment 68 of FIG. 13, these including a pair of elongated supports (or again blades) 70 and 72, the first elongated support 70 exhibiting a first arcuately extending point 74 (cutting blade) and the second support 72 exhibiting a further arcuately extending point configured by an anvil 74 against which the blade 74 is displaced to section the desired hair braid or other threaded item. Additional features include a collar shaped fulcrum 78 guiding separated portions of the elongated supports 70 and 72, such as in a manner previously described, as well as end-projecting comb teeth portions 80 provided as an additional grooming implement.

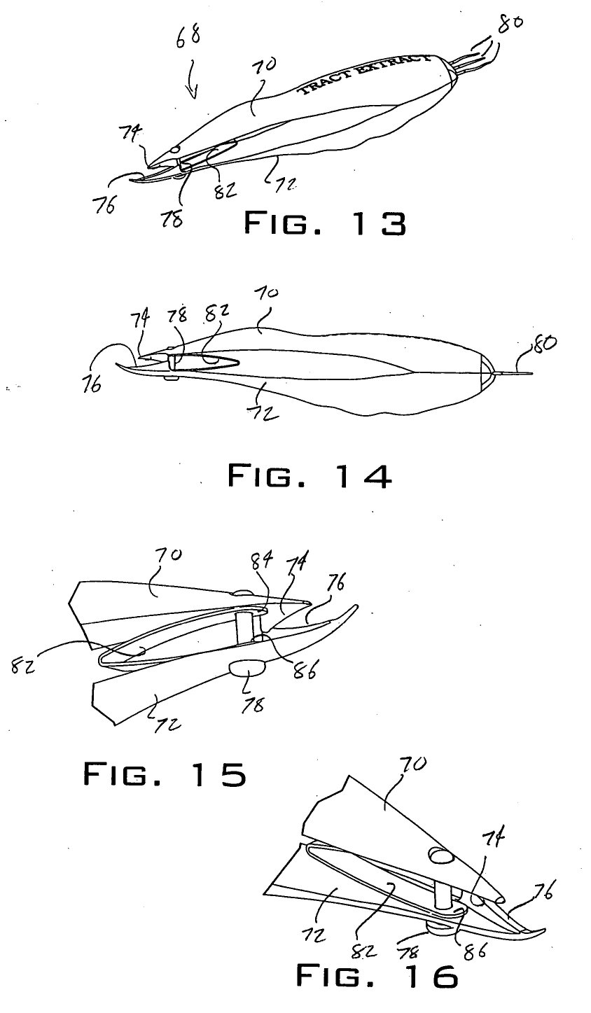

FIGS. 13 and 14 also illustrate the provision of a hairpin shaped and outwardly biasing component 82. The hair pin biasing component includes extending ends 84 and 86 (see FIGS. 15 and 16) disposed against inner facing edges of the blade 74 and anvil 76 supports, respectively and such as by annular apertures seating therethrough the collar-shaped fulcrum 78 so as to be supported thereby.

As previously described, the use of the hairpin component 82 substitutes for requirement of pre-stressing of the elongated supports 70 and 72, associated with the blade and anvil components, in an outward and opposite biasing fashion. The use of the hairpin 82 is particularly desirable in instances where the body of the device is constructed of a plastic or other synthetic material, and which therefore may not exhibit the deformative properties of other materials such as stainless steel, which render practicable the introduction of pre-biasing to the elongated supports 70 and 72.

Having described my invention, other and additional preferred embodiments will become apparent to those skilled in the art to which it pertains, and without deviating from the scope of the appended claims. In particular, it is contemplated that the present invention is also capable of being utilized as a surgical device for removing stitches from a patient, this in addition to a number of other applications to which the present invention can be applied.

I claim:

1. A thread extraction device, comprising:
a first elongated support;
a second pivotally attached and elongated support; and
opposing surfaces of said first and second supports defining at least a blade and an anvil support.

2. The thread extraction device as described in claim 1, further comprising a plurality of comb teeth extending in spaced apart and parallel fashion from an end of said device opposite said blade and anvil support.

3. The thread extraction device as described in claim 1, said first elongated support further comprising an inwardly facing blade, said second elongated support further comprising a recessed surface coacting with said blade.

4. The thread extraction device as described in claim 1, further comprising an actuating lever for pivoting said first and second elongated supports together in coacting fashion.

5. The thread extraction device as described in claim 1, further comprising a plasticized handle fixedly supporting said first elongated support.

6. The thread extraction device as described in claim 5, said handle further comprising an ergonomic configuration.

7. The thread extraction device as described in claim 6, said pivot point further comprising a collar-shaped fulcrum, said first and second supports overlapping in substantially parallel fashion.

8. The thread extraction device as described in claim 1, said first and second elongated supports terminating in substantially pointed ends.

9. The thread extraction device as described in claim 1, further comprising a written indicia applied to a surface of a selected support.

10. The thread extraction device as described in claim 6, said handle further comprising an angled end portion in coacting and displacing contact with an exterior location of said fulcrum.

11. The thread extraction device as described in claim 1, further comprising a hairpin shaped component interposed between inner opposing facing and spatially displaced surfaces associated with said first and second supports.

12. The thread extraction device as described in claim 11, further comprising extending ends of said hairpin biasing component exhibiting apertures for seating therethrough a collar-shaped fulcrum engaging said inner opposing surfaces of said first and second supports.

13. A hair weave tract extraction device, comprising:
an elongated and arcuate extending body having a first pointed end and a second end terminating in a plurality of axially extending comb portions; and
a blade edge configured in extending fashion along said body and proximate said first pointed end.

14. A hair thread extraction device, comprising:
a first elongated support comprising a first inwardly facing blade;
a second pivotally attached and elongated support comprising a recessed surface coacting with said blade, said first and second elongated supports terminating in substantially pointed ends; and
an actuating lever for pivoting said first and second elongated supports together in coacting fashion.

15. The device according to claim 14, further comprising a plurality of comb teeth extending in spaced apart and parallel fashion from an end of said device opposite said blade and recessed support.

16. The device according to claim 14, further comprising a plasticized handle fixedly supporting said first elongated support, said handle further comprising an ergonomic configuration.

17. The device as described in claim 14, said pivot point further comprising a collar-shaped fulcrum, said first and second supports overlapping in substantially parallel fashion.
